(19) United States
(12) Patent Application Publication
(10) Pub. No.: US 2005/0259681 A1
(43) Pub. Date: Nov. 24, 2005

(54) GPRS class B communications system and data transmission method employed therein

(76) Inventor: Yen-Hung Lai, Taipei City (TW)

Correspondence Address: CHRISTIE, PARKER & HALE, LLP, PO BOX 7068, PASADENA, CA, 91109-7068, US

(21) Appl. No.: 11/131,678

(22) Filed: May 17, 2005

(30) Foreign Application Priority Data
May 21, 2004 (TW) 093114350

(51) Int. Cl. H04J 3/16

(52) U.S. Cl. 370/466

(57) ABSTRACT

In a General Packet Radio Service (GPRS) Class B communications system, a mobile station includes a packet generating module for generating data packets to be transmitted wirelessly by the mobile station. The packet generating module is capable of receiving voice data and non-voice data, and is operable in a multi-content mode, in which the packet generating module encapsulates the voice data and the non-voice data to result in the data packets. In addition, a data transmission method for synchronous transmission of voice and non-voice data is to be implemented using a GPRS Class B communications system that includes a mobile station. The data transmission method includes configuring a packet generating module of the mobile station to encapsulate the voice data and the non-voice data to result in data packets that are to be wirelessly transmitted by the mobile station for subsequent reception by a network server.

### CROSS-REFERENCE TO RELATED APPLICATION

This application claims priority of Taiwanese application no. 093114350, filed on May 21, 2004.

### BACKGROUND OF THE INVENTION

1. Field of the Invention

The invention relates to a GPRS Class B communications system capable of generating data packets that contain both voice and non-voice data. This invention also relates to a data transmission method for synchronous transmission of voice and non-voice data and to be implemented using a GPRS Class B communications system.

2. Description of the Related Art

Global System for Mobile Communications (GSM) is currently the most popular standard for mobile voice service communications in the world. Circuit Switched Data (CSD) is a form of data transmission developed for the GSM mobile phone system. In addition, General Packet Radio Service (GPRS) is a packet-switched mobile data service available in the GSM mobile phone system. GPRS devices can be classified as Class A, Class B or Class C, depending on how the device works. In particular, a GPRS class A device can be connected to both GSM and GPRS networks simultaneously. This means that the GPRS Class A device permits voice calls to be made while there is an Internet connection without any service interruption. On the other hand, while a GPRS Class B device permits simultaneous registration on both GSM and GPRS networks, there can only be a voice call or a data connection at a time. In other words, data services can resume only upon termination of a voice call. Finally, a GPRS Class C device permits registration on only one network, GSM or GPRS, and thus cannot process events from both networks at the same time. GPRS Class C devices are generally used for data services, and are seldom used for voice calls.

While it is apparent from the foregoing that the GPRS Class A devices offer better services than the GPRS Class B and Class C devices, there are few GPRS Class A devices currently available on the market since they are not supported by most carriers. Most mobile phones that are currently sold on the market are actually GPRS Class B devices.

Conventional GPRS Class B devices are disadvantageous in that they do not permit simultaneous transmission of voice and non-voice data. For example, whenever there is an active voice call, the conventional GPRS Class B devices do not permit transmission of GSM Short Message Service (SMS) data, such as LoCation Service (LCS) data.

### SUMMARY OF THE INVENTION

Therefore, an object of the present invention is to provide a GPRS Class B communications system capable of generating data packets that contain both voice and non-voice data.

Another object of the present invention is to provide a data transmission method for synchronous transmission of voice and non-voice data and to be implemented using a GPRS Class B communications system.

In the first aspect of this invention, a General Packet Radio Service (GPRS) Class B communications system comprises a mobile station that includes a packet generating module for generating data packets to be transmitted wirelessly by the mobile station. The packet generating module is capable of receiving voice data and non-voice data, and is operable in a multi-content mode, in which the packet generating module encapsulates the voice data and the non-voice data to result in the data packets.

In the second aspect of this invention, a General Packet Radio Service (GPRS) Class B communications system comprises:
a first data source for providing voice data;
a second data source for providing non-voice data; and
a packet generating module coupled to the first and second data sources for generating data packets to be transmitted wirelessly by the mobile station, the packet generating module receiving the voice data and the non-voice data from the first and second data sources and being operable in a multi-content mode, in which the packet generating module encapsulates the voice data and the non-voice data to result in the data packets.

In the third aspect of this invention, a data transmission method for synchronous transmission of voice and non-voice data is to be implemented using a General Packet Radio Service (GPRS) Class B communications system that includes a mobile station. The data transmission method comprises configuring a packet generating module of the mobile station to encapsulate the voice data and the non-voice data to result in data packets that are to be wirelessly transmitted by the mobile station for subsequent reception by a network server.

### BRIEF DESCRIPTION OF THE DRAWINGS

Other features and advantages of the present invention will become apparent in the following detailed description of the preferred embodiment with reference to the accompanying drawings, of which:

FIG. 1 is a simplified schematic circuit block diagram to illustrate relevant components of a mobile station and a network server of the preferred embodiment of a GPRS Class B communications system according to this invention;

FIG. 2 is a flow chart illustrating how the network server switches from a single-content processing mode to a multi-content processing mode in accordance with this invention; and

FIG. 3 illustrates how the mobile station and the network server interact with each other when a packet generating module of the mobile station operates in a multi-content mode in accordance with this invention.

### DETAILED DESCRIPTION OF THE PREFERRED EMBODIMENT

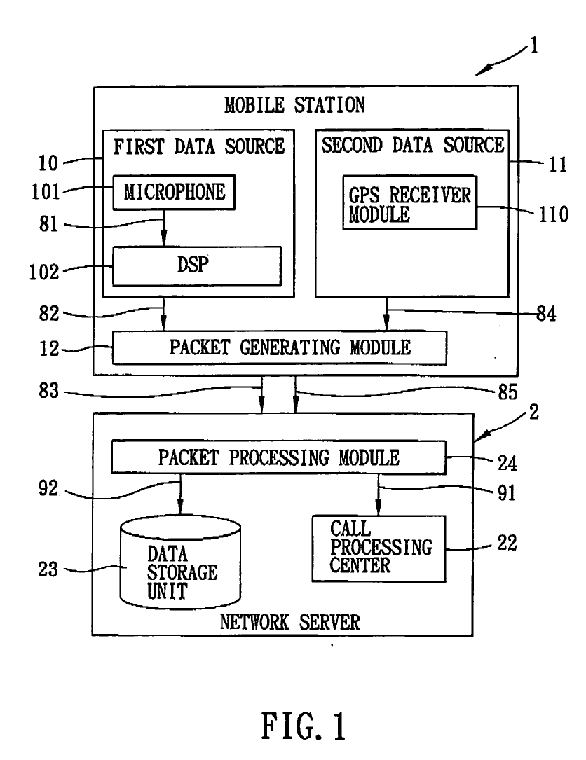

Referring to FIG. 1, the preferred embodiment of a General Packet Radio Service (GPRS) Class B communications system according to the present invention is shown to comprise a mobile station 1 and a network server 2 that communicate wirelessly with each other.

The mobile station 1, which is a mobile phone in this embodiment, includes a first data source 11 for providing voice data, a second data source 11 for providing non-voice data, and a packet generating module 12 coupled to the first and second data sources 10, 11 so as to receive the voice data and the non-voice data therefrom. In this embodiment, the first data source 10 provides Global Service for Mobile Communications (GSM) voice service data, and includes a microphone 101 and a digital signal processor (DSP) 102 coupled to the microphone 101. The non-voice data provided by the second data source 11 is preferably GSM Short Message Service (SMS) data. More preferably, the GSM SMS data is LoCation Service (LCS) data indicative of current location of the mobile station 1. Hence, the second data source 11 includes a Global Positioning System (GPS) receiver module 110 such that the non-voice data includes real-time GPS location data.

The packet generating module 12 generates data packets to be transmitted wirelessly by the mobile station 1. Through actuation of function keys (not shown) of the mobile station 1 by the user, such as a phone service subscriber, operation of the packet generating module 12 can be switched between a single-content mode and a multi-content mode. When the single-content mode is selected, the first data source 10 and the packet generating module 12 are activated, and user sounds are picked up by the microphone 101 of the first data source 10 to result in an analog call signal 81 that is received by the DSP 102. The DSP 102 processes the call signal 81, such as through Adaptive Multi-Rate (AMR) processing, to result in compressed voice data 82 that is provided to the packet generating module 12. The packet generating module 12 then encapsulates the voice data 82 to result in first-type data packets 83 that comply with GPRS protocols. Finally, the first-type data packets 83 are transmitted wirelessly through a transceiver module (not shown) of the mobile station 1 for subsequent reception by the network server 2 in a conventional manner.

On the other hand, when the multi-content mode is selected, the first data source 10, the second data source 11 and the packet generating module 12 are activated, the first data source 10 provides the compressed voice data 82 in the manner described beforehand, and the second data source 11 provides the non-voice data 84 (i.e., GSM SMS data, particularly LCS data). The packet generating module 12 receives the voice data 82 and the non-voice data 84 from the first and second data sources 10, 11, and encapsulates the voice data 82 and the non-voice data 84 to result in second-type data packets 85 that comply with GPRS protocols. Each of the second-type data packets 85 has a packet frame that includes a user identification (User_ID) field, a session identification (Session_ID) field, a non-voice data (i.e., LCS data) length field, anon-voice data (i.e., LCS data) field, a voice data (i.e., GSM voice service data) length field, and a voice data (i.e., GSM voice service data) field. Finally, the second-type data packets 85 are transmitted wirelessly through a transceiver module (not shown) of the mobile station 1 for subsequent reception by the network server 2 in a conventional manner.

In this embodiment, the second data source 11 is embedded in the mobile station 1. However, it should be apparent to those skilled in the art that, in other embodiments of this invention, the second data source 11 may be configured as an external accessory, which may be sold separately, for the mobile station 1. In addition, the non-voice data should not be limited to the above-exemplified LCS data (i.e., GPS location data) In other embodiments, the second data source 11 may be configured to generate other types of non-voice data, such as biometric data (e.g., pulse rate) of the user.

The network server 2 receives the data packets 83 (85) transmitted wirelessly by the mobile station 1, and includes a data storage unit 23, a call processing center 22, and a packet processing module 24 coupled to the data storage unit 23 and the call processing center 22. The network server 2 operates in one of a single-content processing mode and a multi-content processing mode in response to operation of the mobile station 1 in the single-content or multi-content mode.

In particular, the network server 2 operates in the single-content processing mode when the mobile station 1 operates in the single-content mode. When operating in the single-content processing mode, a transceiver module (not shown) of the network server 2 receives the data packets 83 from the mobile station 1, and provides the same to the packet processing module 24. The packet processing module 24 then de-encapsulates the data packets 83 to recover voice data 91 corresponding to the compressed voice data 82 provided by the first data source 10 of the mobile station 1. The recovered voice data 91 is provided to the call processing center 22 for subsequent processing in a conventional manner. As a result, mobile station users are able to converse with each other through the network server 2 in the GPRS Class B communications system of this invention.

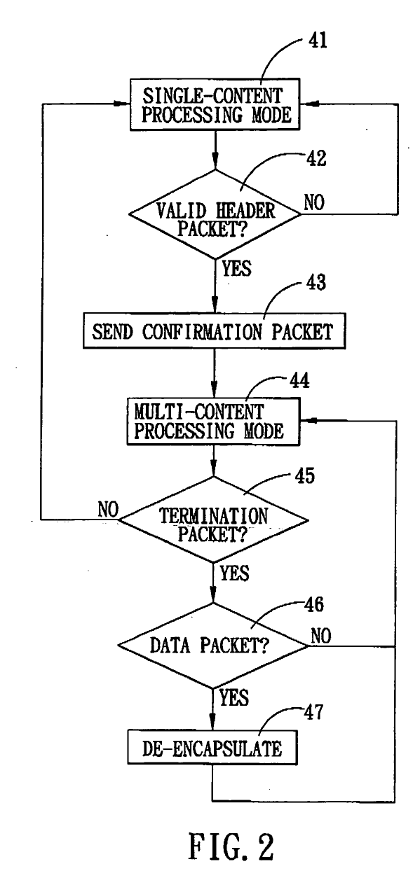

FIG. 2 illustrates how the network server 2 switches from the single-content processing mode to the multi-content processing mode in accordance with this invention. Initially, in step 41, the network server 2 operates in the single-content processing mode as its default mode. In step 42, the network server 2 determines if a valid header packet (i.e., the header packet contains an authorized user identification and a correct user password) for mode switching was received thereby. In the affirmative, the flow proceeds to step 43, where the network server 2 sends a confirmation packet in response to the valid header packet, and then to step 44, where the network server 2 switches operation to the multi-content processing mode. If a valid header packet was not received in step 42, the network server 2 need not make any response, and instead continues to operate in the single-content processing mode (step 41).

When operating in the multi-content processing mode, the network server 2 determines in step 45 if a termination packet was received thereby. In the affirmative, operation in the multi-content processing mode is terminated, and the network server 2 resumes operation in the single-content processing mode (step 41). If the termination packet was not received, the flow proceeds to step 46, where the network server 2 determines if a data packet 85 (see FIG. 1), which contains both the voice data 82 provided by the first data source 10 and the non-voice data 84 provided by the second data source 11 of the mobile station 1, was received thereby. In the affirmative, step 47 is performed, where the packet processing module 24 of the network server 2 de-encapsulates the data packet 85 to recover the voice data 91 corresponding to the compressed voice data 82 from the first data source 10, and non-voice data 92 corresponding to the non-voice data 84 from the second data source 11. The recovered voice data 91 is provided to the call processing center 22 for subsequent processing. On the other hand, the recovered non-voice data 92 is provided to the data storage unit 23 for storage, and is thus available for future reference.

When a data packet 85 was not received in step 46, or after packet de-encapsulation by the packet processing module 24 in step 47, the flow goes back to step 44. Hence, the network server 2 continues to operate in the multi-content processing mode until the termination packet was received thereby (step 45).

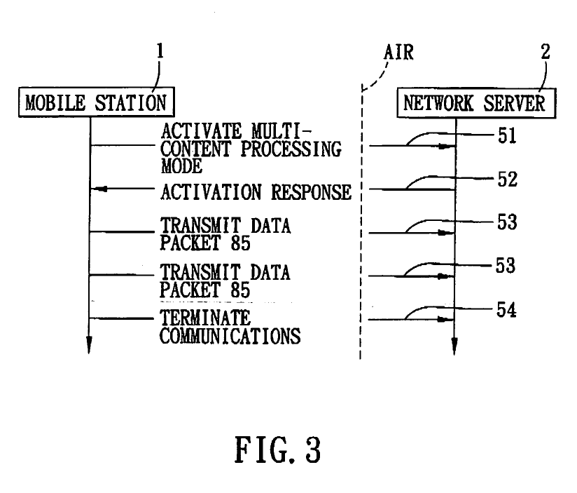

FIG. 3 illustrates how the mobile station 1 and the network server 2 interact with each other when the packet generating module 12 of the mobile station 1 operates in the multi-content mode in accordance with this invention. Initially, in step 51, the mobile station 1 transmits the header packet for activating operation of the network server 2 in the multi-content processing mode. The header packet has a packet frame that includes a user identification field, a user password field, and a session identification field.

Upon receipt of the header packet, and upon determining that the header packet is a valid one, the network server 2 not only switches operation to the multi-content processing mode, but also sends the confirmation packet to the mobile terminal 1 in response to the header packet (step 52). Upon receipt of the confirmation packet, the mobile terminal 1 begins transmission of the data packets 85 (see FIG. 1), which contain both the voice data 82 provided by the first data source 10 and the non-voice data 84 provided by the second data source 11, generated by the packet generating module 12 of the mobile station 1 (step 53). Finally, upon determination by the mobile station 1 that the user intends to terminate communications with the network server 2, the mobile station 1 sends the termination packet to the network server 2 (step 54). In response to the termination packet, the network server 2 terminates operation in the multi-content processing mode, and resumes its operation in the single-content processing mode.

It has thus been shown that, in the GPRS Class B communications system and data transmission method of this invention, transmission of non-voice data (i.e., GSM SMS data, such as LCS data) is possible even when there is an active voice call. Synchronous transmission of voice and non-voice data in the present invention results in better services as compared to conventional GPRS Class B devices.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A General Packet Radio Service (GPRS) Class B communications system comprising a mobile station that includes a packet generating module for generating data packets to be transmitted wirelessly by said mobile station, said packet generating module being capable of receiving voice data and non-voice data and being operable in a multi-content mode, in which said packet generating module encapsulates the voice data and the non-voice data to result in the data packets.

2. The GPRS Class B communications system of claim 1, wherein said packet generating module is operable in a selected one of a single-content mode and the multi-content mode, said packet generating module encapsulating the voice data to result in the data packets when operated in the single-content mode.

3. The GPRS Class B communications system of claim 1, wherein said mobile station further includes a first data source coupled to said packet generating module, said first data source providing the voice data to said packet generating module.

4. The GPRS Class B communications system of claim 3, wherein the voice data is Global system for Mobile Communications (GSM) voice service data.

5. The GPRS Class B communications system of claim 4, wherein the voice data is in an adaptive multi-rate (AMR) compressed format.

6. The GPRS Class B communications system of claim 3, wherein said mobile station further includes a second data source coupled to said packet generating module, said second data source providing the non-voice data to said packet generating module.

7. The GPRS Class B communications system of claim 6, wherein the non-voice data is Global System for Mobile Communications (GSM) Short Message Service (SMS) data.

8. The GPRS Class B communications system of claim 7, wherein the GSM SMS data is LoCation Service (LCS) data.

9. The GPRS Class B communications system of claim 6, wherein said second data source includes a Global Positioning System (GPS) receiver module, and the non-voice data includes GPS location data.

10. The GPRS Class B communications system of claim 9, wherein said mobile station is a mobile phone.

11. The GPRS Class B communications system of claim 1, wherein the data packets comply with GPRS protocols.

12. The GPRS Class B communications system of claim 1, wherein each of the data packets has a packet frame that includes a voice data field for the voice data, and a non-voice data field for the non-voice data.

13. The GPRS Class B communications system of claim 1, further comprising a network server for receiving the data packets transmitted wirelessly by said mobile station, said network server being responsive to operation of said mobile station in the multi-content mode so as to de-encapsulate the data packets in order to recover the voice data and the non-voice data therefrom.

14. A General Packet Radio Service (GPRS) Class B communications system comprising:
a first data source for providing voice data;
a second data source for providing non-voice data; and
a packet generating module coupled to said first and second data sources for generating data packets to be transmitted wirelessly by said mobile station, said packet generating module receiving the voice data and the non-voice data from said first and second data sources and being operable in a multi-content mode, in which said packet generating module encapsulates the voice data and the non-voice data to result in the data packets.

15. The GPRS Class B communications system of claim 14, wherein said packet generating module is operable in a selected one of a single-content mode and the multi-content mode, said packet generating module encapsulating the voice data to result in the data packets when operated in the single-content mode.

16. The GPRS Class B communications system of claim 14, wherein the voice data is Global System for Mobile Communications (GSM) voice service data.

17. The GPRS Class B communications system of claim 16, wherein the voice data is in an adaptive multi-rate (AMR) compressed format.

18. The GPRS Class B communications system of claim 14, wherein the non-voice data is Global System for Mobile Communications (GSM) Short Message Service (SMS) data.

19. The GPRS Class B communications system of claim 18, wherein the GSM SMS data is LoCation Service (LCS) data.

20. The GPRS Class B communications system of claim 14, wherein said second data source includes a Global Positioning System (GPS) receiver module, and the non-voice data includes GPS location data.

21. The GPRS Class B communications system of claim 14, wherein the data packets comply with GPRS protocols.

22. The GPRS Class B communications system of claim 14, wherein each of the data packets has a packet frame that includes a voice data field for the voice data, and a non-voice data field for the non-voice data.

23. A data transmission method for synchronous transmission of voice and non-voice data and to be implemented using a General Packet Radio Service (GPRS) Class B communications system that includes a mobile station, said data transmission method comprising:
configuring a packet generating module of the mobile station to encapsulate the voice data and the non-voice data to result in data packets that are to be wirelessly transmitted by the mobile station for subsequent reception by a network server.

24. The data transmission method of claim 23, wherein the voice data is Global System for Mobile Communications (GSM) voice service data.

25. The data transmission method of claim 24, wherein the voice data is in an adaptive multi-rate (AMR) compressed format.

26. The data transmission method of claim 23, wherein the non-voice data is Global System for Mobile Communications (GSM) Short Message Service (SMS) data.

27. The data transmission method of claim 26, wherein the GSM SMS data is LoCation Service (LCS) data.

28. The data transmission method of claim 23, wherein the non-voice data includes Global Positioning System (GPS) location data provided by a GPS receiver module.

29. The data transmission method of claim 23, wherein the data packets comply with GPRS protocols.

30. The data transmission method of claim 23, wherein each of the data packets has a packet frame that includes a user identification field, a session identification field, a voice data field for the voice data, and a non-voice data field for the non-voice data.

31. The data transmission method of claim 23, further comprising, prior to wireless transmission of the data packets, transmitting a header packet that includes a user identification field and a user password field.
